(19) United States
(12) Patent Application Publication
(10) Pub. No.: US 2007/0293060 A1
(43) Pub. Date: Dec. 20, 2007

(54) Electrical connector

(76) Inventor: Ted Ju, Keelung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/452,351

(22) Filed: Jun. 14, 2006

(51) Int. Cl. H01R 12/00

(52) U.S. Cl. 439/66

(57) ABSTRACT

An electrical connector includes a base and a plurality of pins. There are a plurality of pin-receiving slots on the base. The pins are installed in the pin-receiving slots. There is a contacting part on one end of the pin and a joining-connection part on another end of the pin. The joining-connection part is used for joining and connecting a solder ball. The solder ball is located between an upper surface of the joining-connection part of the pin and a lower surface of the base. The manufacturing process of the electrical connector of the present invention is easy, and enhances production efficiency.

### BACKGROUND OF THE INVENTION

1. Field of the Invention

The present invention relates to an electrical connector.

2. Description of the Related Art

China patent CN200410044726.1 discloses an electrical connector. The electrical connector includes a base and a plurality of pins. There are a plurality of pin-receiving slots on the base. The pins are received in the pin-receiving slots. There is a contacting part on one end of the pin, and there is a connection flake on another end of the pin. The connection flake is soldered with a solder ball and a convex part located at the connection flake is embedded into the solder ball. During manufacturing this electrical connector with the solder ball by via the above method, it is necessary to develop the solder ball slot. The necessity of having to develop the solder ball slot increases manufacturing time.

### SUMMARY OF THE INVENTION

One particular aspect of the present invention is to provide an electrical connector in which the solder ball slot does not need to be developed.

The electrical connector includes a base and a plurality of pins. There are a plurality of pin-receiving slots on the base. The pins are installed in the pin-receiving slots. There is a contacting part on one end of the pin, and there is a joining-connection part on another end of the pin. The joining-connection part is used for joining and connecting a solder ball. The solder ball is located between an upper surface of the joining-connection part of the pin and a lower surface of the base.

The manufacturing process of the electrical connector of the present invention is easy and enhances production efficiency.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is an amplified view of a part of the electrical connector of the present invention;

FIG. 2 is a perspective view of the insulating body of the electrical connector of the present invention;

FIG. 3 is an amplified view of the second embodiment of the electrical connector of the present invention;

FIG. 4 is an amplified view of the third embodiment of the electrical connector of the present invention; and

FIG. 5 is an amplified view of the fourth embodiment of the electrical connector of the present invention.

### DETAILED DESCRIPTION OF THE PREFERRED EMBODIMENTS

The electrical connector of the present invention is illustrated by referring to the attached diagrams and the preferred embodiment.

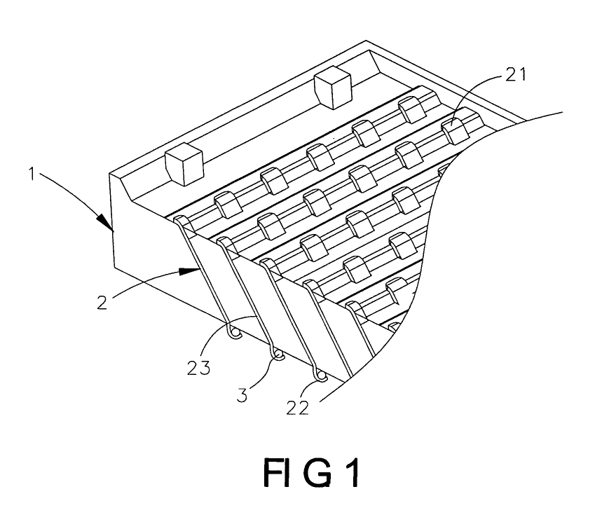

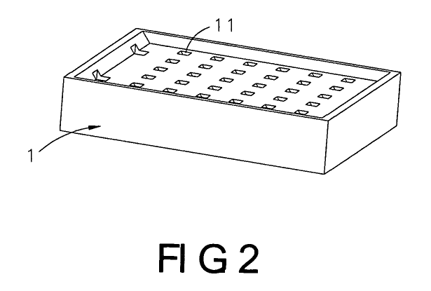

Reference is made to FIG. 1 and FIG. 2. The electrical connector includes a base 1 and a plurality of pins 2. There are a plurality of pin-receiving slots 11 on the base 1.

The pins 2 are installed in the pin-receiving slots 11. The pin 2 has a contacting part 21 located on one end of the pins, a joining-connection part 22 located on another end of the pin 2, and a holding part 23 located between the contacting part 21 and the joining-connection part 22. The holding part 23 is installed using a tilting method. The joining-connection part 22 is formed by bending and then extending the end of the holding part 23. The cross section of the joining-connection part 22 has an arc shape. The joining-connection part 23 is used for joining and connecting a solder ball 3. The solder ball 3 is located between an upper surface of the joining-connection part 22 of the pin 2 and a lower surface of the base 1. The contacting part 21 includes a flexible part.

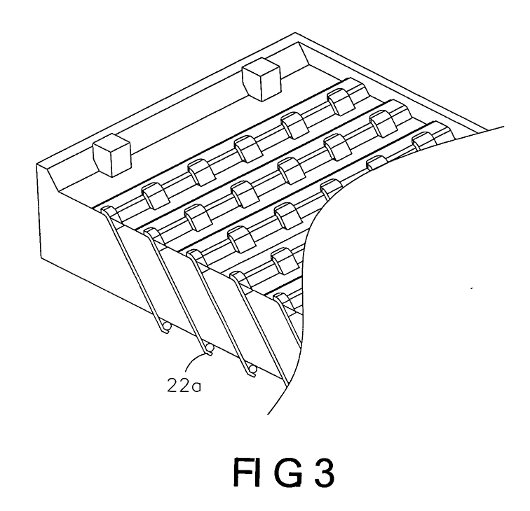

FIG. 3 is an amplified view of the second embodiment of the electrical connector of the present invention. The difference between the second embodiment and the first embodiment is that the joining-connection part 22a has a horizontal shape. The manufacturing process of the electrical connector is easy, and enhances production efficiency.

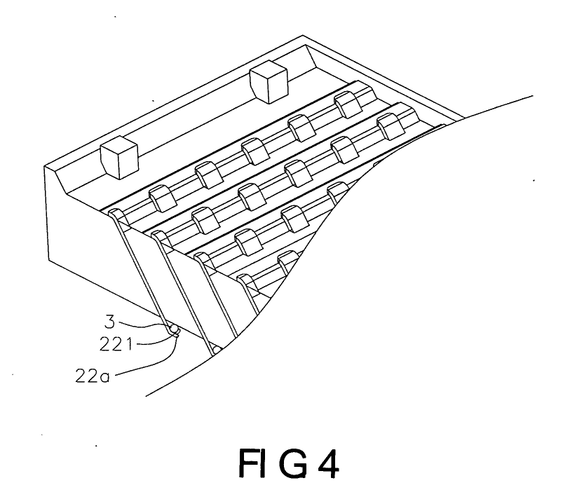

FIG. 4 is an amplified view of the third embodiment of the electrical connector of the present invention. The difference between the third embodiment and the second embodiment is that the joining-connection part 22a includes at least one hooking part 221 used for fastening the solder ball 3. The hooking part 221 is formed by punching the joining-connection part 22a. The hooking part 221 pushes and contacts the external surface of the solder ball 3. The manufacturing process of the electrical connector is easy, and enhances production efficiency.

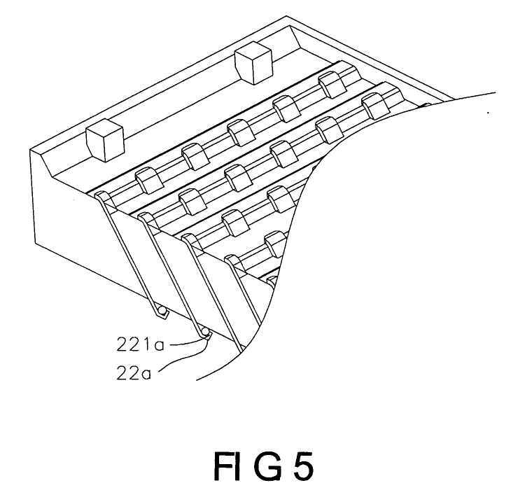

FIG. 5 is an amplified view of the fourth embodiment of the electrical connector of the present invention. The difference between the fourth embodiment and the third embodiment is that the hooking part 221a is formed by bending the end of the joining-connection part 22a. The hooking part 221 pushes and contacts the external surface of the solder ball 3. The manufacturing process of the electrical connector is easy, and enhances production efficiency.

The description above only illustrates specific embodiments and examples of the invention. The invention should therefore cover various modifications and variations made to the herein-described structure and operations of the invention, provided they fall within the scope of the invention as defined in the following appended claims.

1. An electrical connector, comprising:
a base having a plurality of pin-receiving slots formed therein; and
a plurality of pins received in the pin receiving slots, each of the pins including a contacting part on one end thereof and a joining-connection part on another end thereof, a holding part joining said contacting part and said joining-connection part, said holding part and said joining-connection part being formed in one-piece planar formation, the joining-connection part having a bend formed thereon to constrain a solder ball, wherein the solder ball is constrained between an upper surface of the bend in the joining-connection part of the pin and a lower surface of the base.

2. (canceled)

3. The electrical connector as claimed in claim 1, wherein the holding part is installed using a tilting method.

4. The electrical connector as claimed in claim 1, wherein the joining-connection part has an arc shape.

5. The electrical connector as claimed in claim 1, wherein the joining-connection part has a horizontal shape.

6. The electrical connector as claimed in claim 1, wherein the joining-connection part comprises at least one hooking part used for fastening the solder ball.

7. The electrical connector as claimed in claim 6, wherein the hooking part is formed by bending the end of the joining-connection part.

8. The electrical connector as claimed in claim 6, wherein the hooking part is formed by punching the joining-connection part.

9. The electrical connector as claimed in claim 6, wherein the hooking part pushes and contacts an external surface of the solder ball.

10. The electrical connector as claimed in claim 1, wherein the contacting part has a flexible part.
